(19) United States
(12) Patent Application Publication
(10) Pub. No.: US 2025/0128883 A1
(43) Pub. Date: Apr. 24, 2025

(54) ROBOTIC AUTOMATED STORAGE AND RETRIEVAL SYSTEM AND METHOD OF STORING ARTICLES

(71) Applicant: Dematic Corp., Grand Rapids, MI (US)

(72) Inventors: Mark D. O'Brien, Kentwood, MI (US); Kevin M. Heath, Clarksville, MI (US)

(21) Appl. No.: 18/999,663

(22) Filed: Dec. 23, 2024

Related U.S. Application Data
(63) Continuation of application No. 17/323,471, filed on May 18, 2021, now Pat. No. 12,172,837.
(60) Provisional application No. 63/030,429, filed on May 27, 2020.

(51) Int. Cl. B65G 1/137; B65G 1/04

(52) U.S. Cl. CPC B65G 1/1373; B65G 1/0435

(57) ABSTRACT

An automated storage and retrieval system and method of storing articles to and retrieving articles from at least one stacked storage rack that is configured to store articles double deep in each storage location with one article at a front position and another article at a back position behind the one article includes a robot having an end of arm tool (EOAT). The EOAT has a platform and an extendable article manipulator. The platform is sized to support at least two articles. The robotic arm selectively positions the end of arm tool to retrieve articles from front and back storage positions of said at least one stacked storage rack and storing at least one of the articles from the platform to a front or back storage position after the robot rotates the EOAT about a generally vertical axis.

### CROSS REFERENCE TO RELATED APPLICATIONS

The present application is a continuation of U.S. application Ser. No. 17/323,471, now U.S. Pat. No. 12,172,837, and claims priority of U.S. provisional application Ser. No. 63/030,429, filed May 27, 2020, which are both hereby incorporated herein by reference in their entireties.

### BACKGROUND OF THE INVENTION

The present invention is directed to robotic automated storage and retrieval systems (ASRS) that store articles in a shelving system, or stacked rack, which may be provided in pairs around a stationary robot and method of storing articles. The term “robot” is intended to be broadly defined to include arm type robots, gantry type robots and the like. When the articles are stored in double rows of articles, one behind the other, known as double deep storage, the robotic may have an end-of-arm tool (EOAT), such as with long fixed fork extensions mounted to the end of the robot arm. When a desired article is stored in the back row farthest from the robotic arm EOAT, both articles are removed to a stationary location, the remaining load is repositioned on the EOAT and the article from the front row replaced to the rack typically to the back row. This removal process is slow and cumbersome. The rack(s) may be made in circular shapes arranged in a circumference with the robot in the center of the circumference.

### SUMMARY OF THE INVENTION

The present invention provides a robotic automated storage and retrieval system and method of storing and retrieving articles that is significantly faster and more stream-lined than known systems. An automated storage and retrieval system and method of storing articles to and retrieving articles from at least one stacked storage rack that is configured to store articles double deep in each storage location with one article at a front position and another article at a back position behind the one article; according to an aspect of the invention, includes a robot having an end of arm tool (EOAT). The EOAT has a platform and extendable article manipulator. The platform is sized to support at least two articles. The article manipulator is adapted to extend and retract double deep in opposite directions from opposite ends of the platform in order to retrieve at least one article to the platform at a storage location of the at least one stacked storage rack with the article manipulator extending in one of the directions. The robot is adapted to rotate the end of arm tool about a generally vertical axis with the at least one articles on the platform to store at least one article from said platform to the storage location of the at least one of said stacked storage rack with the article manipulator extending in the opposite of the directions.

The extendable article manipulator may concurrently position at least one article to the platform or remove at least one article from the platform. The extendable article manipulator may concurrently remove at least one article from front and back positions of the rack and position the articles to the platform or remove at least one article from the platform and store the article to front or back position of the rack.

The extendable article manipulator may be a platen that is adapted to support at least one article from below or a pair of arms adapted to support at least one article from its sides. The extendable article manipulator may be adapted to support variable width articles. The platform may be a conveying surface. The at least one stacked storage rack may have an arcuate front and may be a pair of stacked storage racks that are facing each other on opposite sides of the robotic positioning device.

An automated storage and retrieval system and method of storing articles to and retrieving articles from at least one stacked storage rack that is configured to store articles double deep in each storage location with one article at a front location and another article at a back location behind the one article, according to an aspect of the invention, includes a robot having an end of arm tool (EOAT). The EOAT has a platform and extendable article manipulator. The platform is sized to support at least two articles. The article manipulator is adapted to extend and retract double deep in opposite directions from opposite ends of the platform in order to retrieve at least two articles to the platform at a storage location of the at least one stacked storage rack with the article manipulator extending in one of the directions. The robotic arm is adapted to rotate the end of arm tool about a generally vertical axis with the at least two articles on the platform to store at least one article from said platform to the storage location of the at least one of the stacked storage rack with the article manipulator extending in the opposite of the directions.

The EOAT may selectively store one of the articles to a front or back storage position after the robotic arm rotates the EOAT and discharges the other of the articles to a discharge conveyor after storing the one of the articles. The extendable article manipulator may be a platen adapted to support at least two articles from below or a pair or arms adapted to support at least two article from its sides. The extendable article manipulator may be adapted to support variable width articles. The platform may have a conveying surface. The at least one stacked storage rack may have an arcuate front and may be a pair of stacked storage racks that are facing each other on opposite sides of the robotic positioning device. The robot may selectively position the end of arm tool to store at least one of the articles from the platform to a front or back storage location after the robot rotates the EOAT 180 degrees about the generally vertical axis.

Other objects, features and advantages will be apparent upon review of the specification and drawings as set forth below.

### BRIEF DESCRIPTION OF THE DRAWINGS

FIG. 1 is a perspective view of an automated storage and retrieval system according to an embodiment of the invention;

FIG. 2 is the same view as FIG. 1 showing the robotic arm selectively positioning the end of arm tool which is retrieving articles from front and back storage locations of a stacked storage rack;

FIG. 3 is the same view as FIG. 2 showing the robot rotating the EOAT 180° about a generally vertical axis;

FIG. 4 is the same view as FIG. 3 showing the robot selectively positioning the end of arm tool and storing the excess article from the platform to a front or back storage location after the robot rotating EOAT 180° about the generally vertical axis;

FIG. 5 is the same view as FIG. 4 showing the arms retracting from the storage rack after storing the excess article and concurrently repositioning the article remaining on the platform;

FIG. 6 shows the robot positioning the EOAT to the outbound conveyor to discharge the article remaining on the platform and picking up an inbound article from the in-bound conveyor;

FIG. 7 is a perspective view of the end of arm tool; and

FIG. 8 is the same view as FIG. 7 of an alternative end of arm tool.

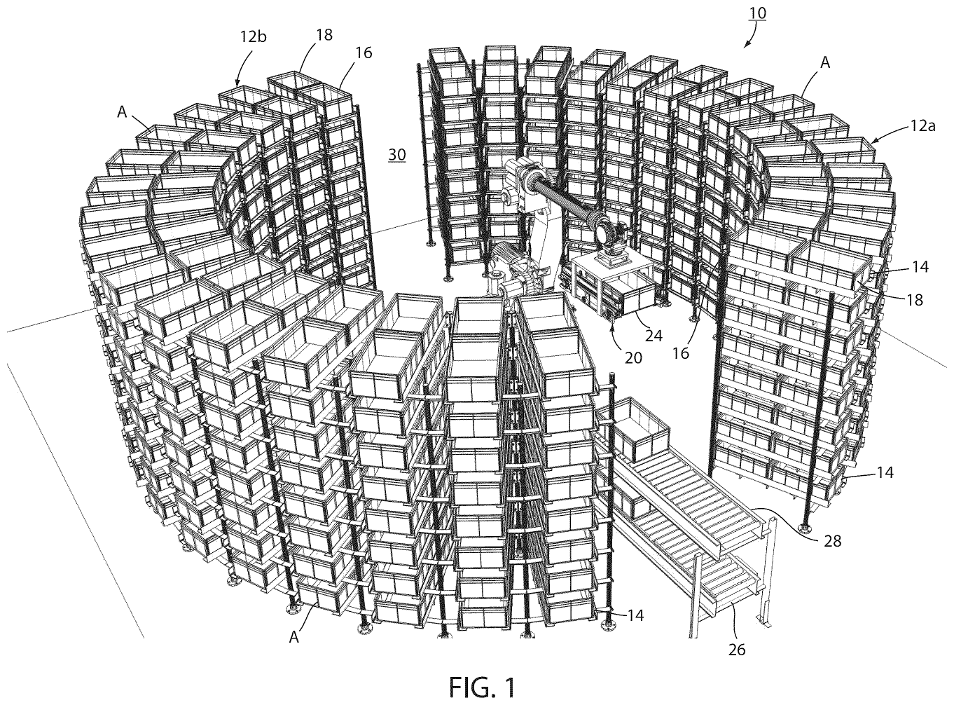

### DESCRIPTION OF THE PREFERRED EMBODIMENTS

Referring now to the drawings and illustrative embodiments depicted therein, a robotic automated storage and retrieval system 10 includes at least one stacked storage rack 12a, 12b that is configured to store articles A double deep rows in each storage location, with one article at a front position or row16 and another article at a back position or row 18 behind the one article. While articles are illustrated as totes, they could be other receptacles such as cartons or trays or could be individual articles. Although the articles are shown being consistent width, the principles of the invention may be used with receptacles or articles of various widths.

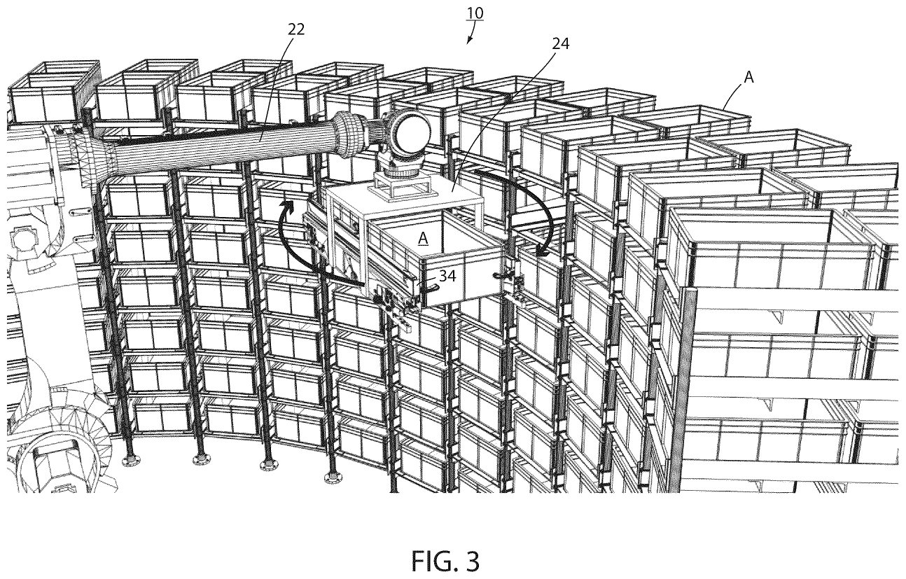

System 10 includes a stationary robot 20 having a robotic arm 22 in the illustrated embodiment and an end of arm tool (EOAT) 24 positioned at a distal end of arm 22. Alternatively, robot 20 may be a gantry-type robot which would have an end of art tool 24. EOAT 24 has a platform 32 and an extendable article manipulator, such as a pair of extendable guides 34, each having actuatable fingers to pull and push on the articles. Platform 32 is sized to support at least two tandem articles. Manipulator 34 is controllable to extend and retract from opposite ends of platform 32 in order to retrieve at least one article from a rack 12a, 12b to platform 32 or to remove at least one article from platform 32 to a rack 12a, 12b. Robot 20 is adapted to rotate end of arm tool 24 about a generally vertical axis as best illustrated in FIG. 3. A programmable control system (not shown) maintains tract of all articles in storage racks 12a, 12b and controls overall operation of robot 20 and end of arm tool 24.

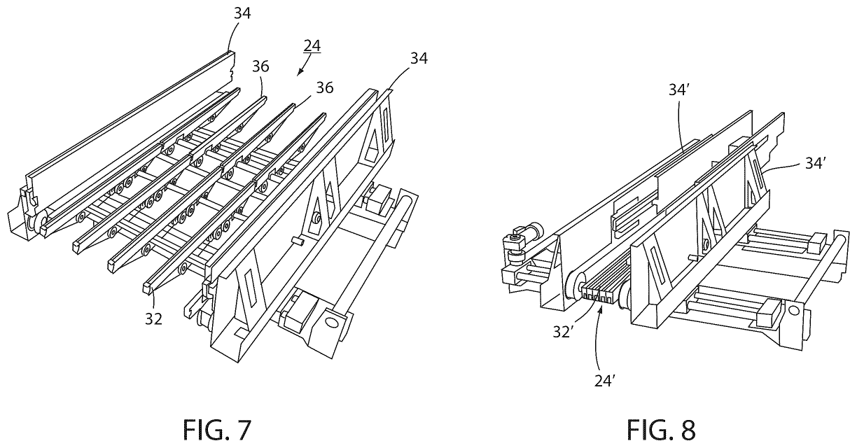

Manipulator 34 is adapted to concurrently position at least two articles to platform 32 or to remove at least one article from the platform, although two or more articles are possible. Manipulator 34 is extendable in opposite directions from open ends of platform 32 in order to concurrently remove up to two articles from front and back storage locations of the rack and to position the articles to the platform; or to remove up to two articles from the platform and store the article to front or back location of the rack. Detailed structure and operation of manipulator 34 is set forth in commonly assigned U.S. Pat. No. 8,790,061, the disclosure of which is hereby incorporated herein by reference in its entirety, and will not be repeated herein. While in the illustrated embodiment, manipulator 34 is extendable guides that are adapted to grasp articles from their sides, the manipulator may alternatively be a platen that is adapted to support at least one article from below or other form of known extendable article manipulator. While manipulator 34 may be of fixed spacing in order to handle articles of consistent width such as totes or trays, they may have variable spacing as shown in FIG. 8 in order to support variable width articles. Platform 32 may be a stationary plate with articles moved to opposite ends of the plate by manipulator 34. Alternatively, platform 32 may be made up of a conveying surface defined by a powered belt or powered belt strips as shown in FIG. 7 and as commercially available by Dematic Corp under the Typhoon brand.

Each stacked storage rack 12a, 12b has an arcuate front although other shapes are possible including parallel flat fronts and the like. Racks 12a, 12b form a pair of stacked storage racks that are facing each other on opposite sides of robot 20 in a generally circular cylindrical configuration.

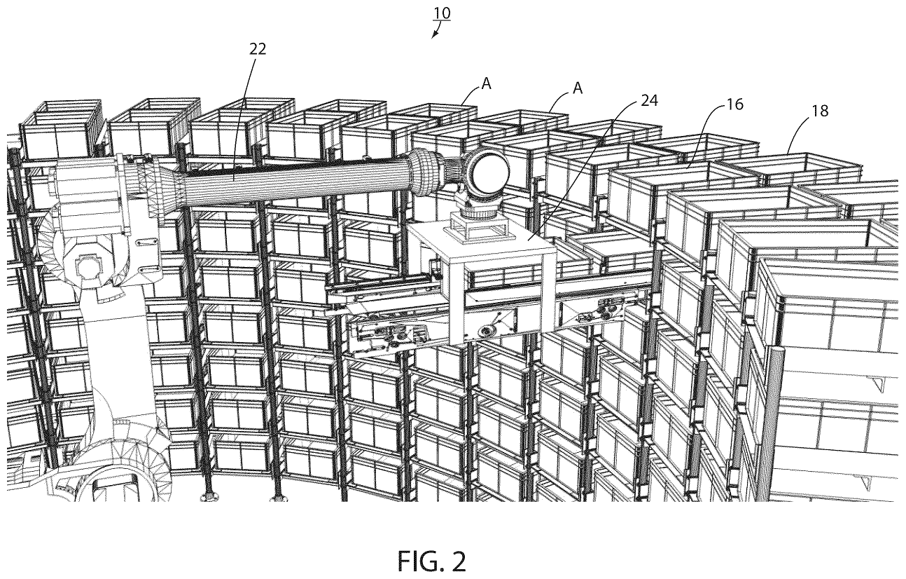

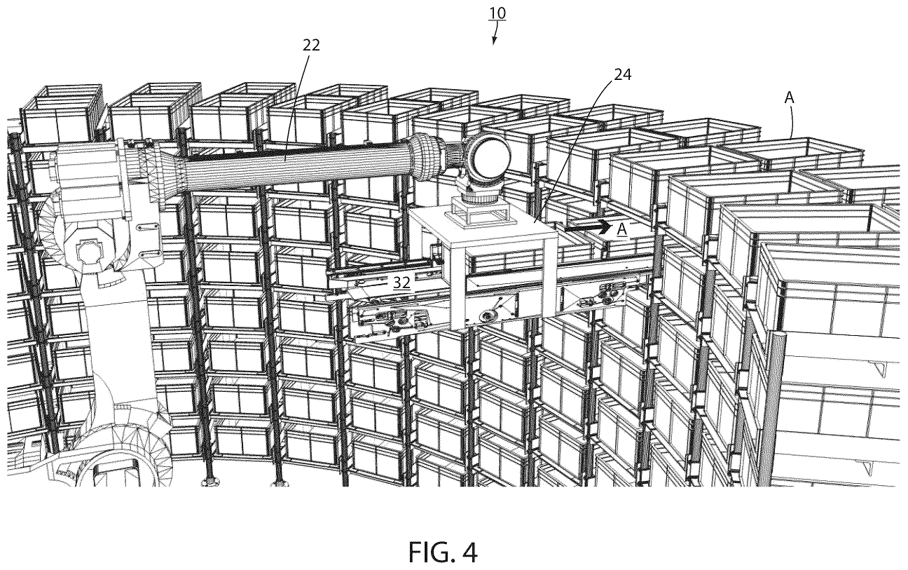

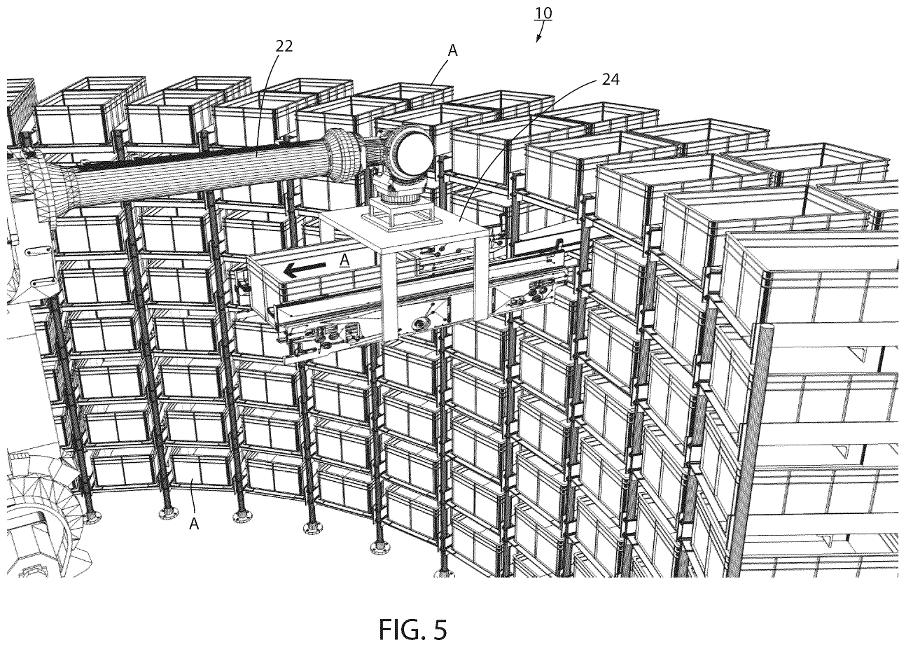

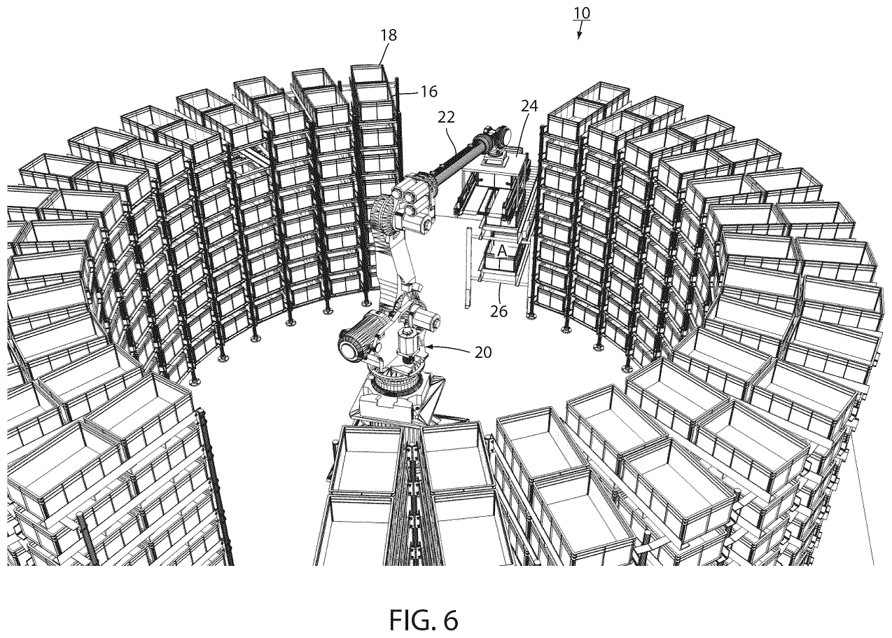

When an article A is desired to be retrieved from back storage position 18 notwithstanding another article A in front storage position 16 in front and blocking the desired article, robot 20 positions end of arm tool 24 at the desired location in storage rack 12 as shown in FIG. 2. Manipulator 34 extends outwardly to double-deep length and pairs of pivoting fingers are actuated in order to engage the front and back articles. The manipulator is then retracted, along with any conveyor of platform 32 being operated, in order to retrieve articles from the front and back storage positions to support the retrieved articles to the platform. EOAT 24 is then rotated 180 degrees about a generally vertical axis at the end of robotic arm 22 as shown in FIG. 3. This positions the blocking article that was removed from the front storage position to be closest to the rack as shown in FIG. 4. The blocking article from the front storage position can be re-stored to either the front or rear storage location by extending manipulator 34 an appropriate length. The desired article to be retrieved from the rear storage position is retained on the platform 32 as shown in FIG. 5 while retracting the manipulator to remove them from the stacked storage rack. Robot 20 then positions EOAT 24 at outbound conveyor 28 and manipulator 34 position the desired article to the outbound conveyor. EOAT 24 may then pick up any in-bound article intended to be put into storage from in-bound conveyor 26 and the process described above is reversed if it is desired to place the in-bound article in a vacant back storage location 18 behind another article already in the front storage location. Alternatively the existing front article could be pushed to the back storage location from the front storage location using manipulator 34 and the incoming article positioned in the open front storage location.

FIG. 7 illustrates details of EOAT 24. FIG. 8 illustrates an alternative EOAT 24′ having manipulator 34′ that are adjustable to variable spacing in order to match the width of variable width articles. This allows articles of variable width, such as individual articles to be handled.

Changes and modifications in the specifically described embodiments can be carried out without departing from the principles of the present invention which is intended to be limited only by the scope of the appended claims, as interpreted according to the principles of patent law including the doctrine of equivalents.

1. An automated storage and retrieval system, comprising:
at least one stacked storage rack that is configured to store at least two articles in each of a plurality of storage locations with one article at a front position and another article at a back position behind the one article;
a robot having an arm and an end of arm tool (EOAT), wherein the EOAT is arranged at a distal end of the arm;
said EOAT having a platform with opposite ends with said platform sized to support at least two articles and adapted to receive at least one article from and place at least one article to individual storage locations of the at least one storage rack from either of the opposite ends of the platform; and
said EOAT being arranged on said distal end of said arm to be rotatable 180 degrees by said robot about a generally vertical axis while maintaining said EOAT in a horizontal orientation to selectively position either of the opposite ends of said platform at the individual storage locations of said at least one stacked storage rack.

2. The system as claimed in claim 1, wherein the plurality of storage locations of the at least one stacked storage rack comprises a plurality of adjacent columns of vertically stacked storage locations with each column of vertically stacked storage locations comprising a plurality of individual storage locations.

3. The system as claimed in claim 2 wherein the at least one stacked storage rack has an arcuate front.

4. The system as claimed in claim 3, wherein the at least one stacked storage rack substantially surrounds the robot, and wherein the at least one stacked storage rack includes an aisle with a conveyor assembly at the aisle for providing in-bound articles to the robot or receiving out-bound articles from the robot.

5. The system as claimed in claim 4, wherein the conveyor assembly comprises an in-bound conveyor for providing in-bound articles to the robot and an out-bound conveyor for receiving out-bound articles from the robot.

6. The system as claimed in claim 4, wherein said at least one stacked storage rack comprises a pair of stacked storage racks that are facing each other on opposite sides of the robot.

7. The system as claimed in claim 1, wherein the EOAT includes an extendable article manipulator that is adapted to extend and retract up to double deep from either of the opposite ends of the platform in order to retrieve at least one article to the platform from the individual storage locations or to place at least one article from the platform to the individual storage locations.

8. The system as claimed in claim 7, wherein the extendable article manipulator is adapted to concurrently position at least two articles to the individual storage locations or to remove at least two articles from the individual storage locations.

9. The system as claimed in claim 7 wherein the extendable article manipulator comprises at least one platen adapted to support at least one article from below or a pair of guides adapted to support at least one article from sides of the at least one article.

10. The system as claimed in claim 7 wherein the extendable article support manipulator is adjustable to support variable width articles.

11. The system as claimed in claim 1 wherein the platform comprises a conveying surface.

12. The system as claimed in claim 1, wherein said EOAT is disposed vertically downwardly from the distal end of the arm and is rotatable beneath the distal end of the arm.

13. An automated storage and retrieval system, comprising:
at least one stacked storage rack that is configured to store at least two articles in each of a plurality of storage locations with one article at a front position and another article at a back position behind the one article;
a stationary robot having an arm and an end of arm tool (EOAT), wherein the EOAT is arranged at a distal end of the arm;
said EOAT having a platform with opposite ends and an extendable article manipulator, with said platform sized to support at least two articles and adapted to receive at least one article from and place at least one article to individual storage locations of the at least one storage rack from either of the opposite ends of the platform, wherein the extendable article manipulator is adapted to extend and retract up to double deep from either of the opposite ends of the platform in order to retrieve at least one article to the platform from the individual storage locations or to place at least one article from the platform to the individual storage locations; and
said EOAT being arranged on said distal end of said arm to be rotatable 180 degrees by said robot about a generally vertical axis while maintaining said EOAT in a horizontal orientation to selectively position either of the opposite ends of said platform at the individual storage locations of said at least one stacked storage rack.

14. The system as claimed in claim 13, wherein each storage location includes a front position for storage of one article and a back position for storage of another article behind the one article, and wherein the stationary robot is adapted to (i) position one end of the EOAT to one said storage location of said at least one stacked storage rack and retrieve articles from said front and said back storage positions at said one said storage location to said platform, (ii) rotate the EOAT 180 degrees about the generally vertical axis at the distal end of the arm with the retrieved articles on the platform to position the opposite said end of the EOAT to said one said storage location, and (iii) store at least one of the retrieved articles from the platform to the front or back storage position at said one said storage location.

15. The system as claimed in claim 14, wherein the at least one stacked storage rack has an arcuate front, and wherein the plurality of storage locations of the at least one stacked storage rack comprises a plurality of adjacent columns of vertically stacked storage locations with each column of vertically stacked storage locations comprising a plurality of individual storage locations.

16. The system as claimed in claim 15, wherein the at least one stacked storage rack substantially surrounds the robot, and wherein the at least one stacked storage rack includes an aisle with a conveyor assembly at the aisle for providing in-bound articles to the robot or receiving out-bound articles from the robot.

17. The system as claimed in claim 13, wherein said EOAT is disposed vertically downwardly from the distal end of the arm and is rotatable beneath the distal end of the arm.

18. A method of receiving articles from and inserting articles to at least one stacked storage rack that is configured to store articles double deep in each of a plurality of storage locations with one article at a front position and another article at a back position behind the one article, said method comprising:
having a robot with an arm and an end of arm tool (EOAT), wherein the EOAT is arranged at a distal end of the arm, the EOAT having a platform with opposite ends and is sized to support at least two articles;
positioning via the robot one of the ends of the platform at a selected one of the storage locations;
receiving onto the platform the one article at the front position and the another article at the back position from the selected one of the storage locations;
positioning the other end of the platform at the selected one of the storage locations by rotating the platform; and
inserting from the platform back into the selected one of the storage locations the one article that had been in the front position prior to being received onto the platform with the another article from the back position remaining on the platform;
wherein said rotating the platform comprises rotating said EOAT 180 degrees about a generally vertical axis at the distal end of the arm while maintaining said EOAT in a horizontal orientation between said receiving and said inserting.

19. The method of claim 18, wherein the EOAT includes an extendable article manipulator, and wherein said method further comprises extending and retracting said article manipulator from one of said ends of said platform during said positioning and said inserting.

20. The method of claim 19, wherein the EOAT is disposed vertically downwardly from the distal end of the arm and is rotatable beneath the distal end of the arm.
